(19) United States
(12) Patent Application Publication
(10) Pub. No.: US 2025/0026931 A1
(43) Pub. Date: Jan. 23, 2025

(54) ADDITION-CURABLE SILICONE COMPOSITION, METHOD FOR MANUFACTURING THE SAME, AND OPTICAL SEMICONDUCTOR DEVICE

(71) Applicant: SHIN-ETSU CHEMICAL CO., LTD., Tokyo (JP)

(72) Inventors: Yuki MAEHARA, Takasaki-shi (JP); Tomoyuki MIZUNASHI, Annaka-shi (JP)

(73) Assignee: SHIN-ETSU CHEMICAL CO., LTD., Tokyo (JP)

(21) Appl. No.: 18/763,130

(22) Filed: Jul. 3, 2024

(30) Foreign Application Priority Data
Jul. 5, 2023 (JP) 2023-111054

(51) Int. Cl. C08L 83/04; C08G 77/08; C08G 77/12; C08G 77/20; C08K 3/22; C08K 3/36; C08K 9/08

(52) U.S. Cl. CPC C08L 83/04; C08G 77/08; C08G 77/12; C08G 77/20; C08K 3/22; C08K 3/36; C08K 9/08; C08K 2003/2227; C08K 2003/2241; C08K 2003/2244; C08K 2003/2296; C08L 2201/08; C08L 2201/10; C08L 2203/206

(57) ABSTRACT

An addition-curable silicone composition includes organopolysiloxane having at least two alkenyl groups bonded to a silicon atom per molecule; an organosilicon compound having at least two silicon atom-bonded hydrogen atoms per molecule; a platinum group metal-based catalyst; and an inorganic oxide particle. The inorganic oxide particle is surface-treated by a polysilazane compound-containing composition that includes an organic solvent and a polysilazane compound in which a ratio of a number of repeating units represented by the following formula (2) is 0 to 0.5 relative to a total number of repeating units represented by the following formulae (1) and (2) wherein in the formulae, R represents a group selected from the group consisting of an aliphatic hydrocarbon group, an aromatic hydrocarbon group, and an alkoxy group.

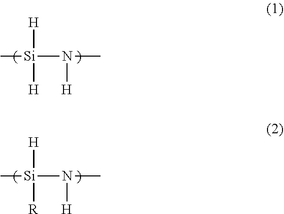

### TECHNICAL FIELD

The present invention relates to an addition-curable silicone composition, a method for manufacturing the same, and an optical semiconductor device.

### BACKGROUND ART

As a resin used for an optical semiconductor device, it has been desired a material excellent in high transparency, high refractive index, high heat dissipation, high reflectivity, mechanical properties, heat resistance, weather resistance, gas barrier properties depending on the application, and thus thermoplastic resins such as an epoxy resin, poly(meth)acrylate and polycarbonate have been frequently used conventionally. However, due to a recent trend toward higher output of an optical semiconductor device, it has come to be found that use of these thermoplastic resins causes a problem of heat resistance, humidity resistance, or discoloration resistance under a prolonged period of time.

In addition, lead-free solders have become to be used often in recent years when an optical device is soldered to a substrate. The lead-free solders have higher melting point than the conventional solders, and accordingly the soldering have to be generally carried out at a temperature of 260° C. or higher. It has also come to be found that, when soldering is carried out at such a temperature, encapsulant of the foregoing conventional thermoplastic resin has problems such as deformation and yellowing due to a high temperature.

As described above, encapsulants are required to be more excellent in heat resistance, humidity resistance, or discoloration resistance than before in association with a trend toward higher output of optical semiconductor devices and use of lead-free solders. In order to improve the heat resistance, optical resin compositions in which a thermoplastic resin is filled with nanosilica have been proposed (Patent Documents 1 and 2), but have failed to give sufficient heat resistance as desired due to a heat resistance limitation of thermoplastic resins itself.

Silicone resins, which are thermosetting resins, have been studied as a material for optical semiconductor device since they have excellent heat resistance, light resistance, and light transparency. These silicone resins by themselves, however, have very high gas permeability (i.e., low gas barrier property), and therefore oxygen or moisture in the air passes through the resins and deteriorates electrodes (Patent Documents 3 and 4).

Furthermore, although gas permeability can be reduced by filling with an inorganic oxide, oxygen and moisture in the air can cause rapid deterioration of the silicone resin via the inorganic oxide particle under high temperatures or high humidity, and even when using inorganic oxide particle subjected to a certain treatment similar to those applied to commercially available inorganic oxide particles, it is not possible to remedy the problems of crack occurring due to a deterioration in mechanical properties, an increase in hardness, etc. (Patent Documents 5 to 7).

As a countermeasure for this, the introduction of aromatic substituents such as phenyl groups to improve gas barrier properties has been studied, but the introduction of aromatic substituents causes a large change in viscoelasticity when heated, which results in problems such as a further decrease in crack resistance compared to methylsilicone resins, and more pronounced yellowing causing decrease of heat resistance and light resistance (Patent Document 8). Therefore, it is desired to develop materials, which can be used for optical semiconductor devices, which have good workability and are excellent in mechanical properties, crack resistance, heat resistance, and moisture resistance after curing.

### CITATION LIST

### Patent Literature

Patent Document 1: JP 2012-214554 A
Patent Document 2: JP 2013-204029 A
Patent Document 3: JP 2006-213789 A
Patent Document 4: JP 2007-131694 A
Patent Document 5: JP 2011-099008 A
Patent Document 6: JP 2015-051924 A
Patent Document 7: JP 2014-125401 A
Patent Document 8: JP 2017-519058 A

### SUMMARY OF INVENTION

### Technical Problem

The present invention has been made in view of the above problems, and aims to provide an addition-curable silicone composition containing inorganic oxide particle, which can provide a cured product that is excellent in mechanical properties, crack resistance, heat resistance, and moisture resistance, and can have low viscosity and excellent workability, and to provide an optical semiconductor device including a cured product obtained by curing the composition. The present invention also provides a method for manufacturing such an addition-curable silicone composition.

### Solution to Problem

To solve the problems, the present invention provides an addition-curable silicone composition, comprising:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle, wherein, the inorganic oxide particle contains an organic solvent and a polysilazane compound in which a ratio of a number of repeating units represented by the following formula (2) is 0 to 0.5 relative to a total number of repeating units represented by the following formulae (1) and (2), and is a surface-treated inorganic oxide particle that is surface-treated with a polysilazane compound-containing composition in which an amount of the polysilazane compound is 0.1 to 20% by mass relative to an total amount of the polysilazane compound and the organic solvent.

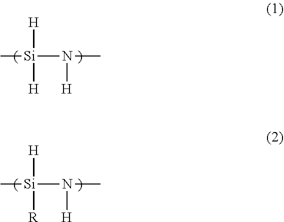

In the formulae, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.

Addition-curable silicone composition using such an inorganic oxide particle can have an excellent workability and can make a cured product of the resin excellent in mechanical properties, crack resistance, heat resistance, and moisture resistance.

Further, R in the formula (2) of the polysilazane compound is preferably a methyl group.

The polysilazane compound having such a methyl group is easy to be prepared.

Further, the polysilazane compound-containing composition preferably contains a curing catalyst.

With such a composition, a surface treatment can be performed at normal temperature in a short time, and workability becomes more excellent.

Further, the inorganic oxide particle preferably contains at least one kind selected from the group consisting of silicon dioxide, zirconium oxide, titanium oxide, aluminum oxide, and zinc oxide.

When an addition-curable silicone composition is added with a surface-treated inorganic oxide particle composition in which such an inorganic oxide particle is surface-treated, the added composition can be made to be especially excellent in mechanical properties, crack resistance, heat resistance, moisture resistance, and workability.

Further, the present invention provides an optical semiconductor device, comprising a cured product of the addition-curable silicone composition according to the above.

In such a semiconductor device, a semiconductor element is sealed with a cured product excellent in mechanical properties, crack resistance, heat resistance, and moisture resistance, and therefore, the optical semiconductor device is excellent in long-term reliability and long-term color rendering properties under high-temperature and high-humidity.

Further, the present invention provides a method for manufacturing an addition-curable silicone composition, comprising:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle, wherein, the method for manufacturing an addition-curable silicone composition comprises the step of:
providing the inorganic oxide particle;
manufacturing a surface-treated inorganic oxide particle by surface-treating the inorganic oxide particle with a polysilazane compound-containing composition that contains an organic solvent and a polysilazane compound, in which a ratio of a number of repeating units represented by the following formula (2) is 0 to 0.5 relative to a total number of repeating units represented by the following formulae (1) and (2), and in which an amount of the polysilazane compound is 0.1 to 20% by mass relative to a total amount of the polysilazane compound and the organic solvent; and
manufacturing the addition-curable silicone composition by mixing the surface-treated inorganic oxide particle with the components (A) to (C)

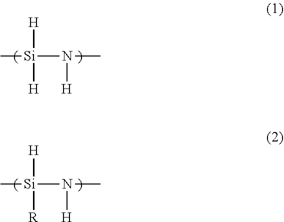

wherein, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.

According to a method for manufacturing an addition-curable silicone composition with using such a surface-treated inorganic oxide particle, the manufactured composition can be excellent in workability and its cured product can be excellent in mechanical properties, crack resistance, heat resistance and moisture resistance.

### Advantageous Effects of Invention

With using the inventive addition-curable silicone composition, the addition-curable silicone composition containing an inorganic oxide particle can be excellent in workability and its cured product can be excellent in mechanical properties, crack resistance, heat resistance and moisture resistance.

### DESCRIPTION OF EMBODIMENTS

As mentioned above, in order to meet the operating conditions of recent semiconductor devices, it has been desired to improve high heat resistance, high moisture resistance, workability, etc.

The present inventors have diligently studied to solve the above problems and consequently found: when an addition-curable silicone composition contains a surface-treated inorganic oxide particle that was surface-treated with a polysilazane compound-containing composition satisfying a modification rate within a prescribed range, the cured product can be excellent in mechanical properties, crack resistance, heat resistance, and moisture resistance; the composition can have a low viscosity and excellent workability also after addition of the inorganic oxide particle; and further, such an addition-curable silicone composition can be suitably used for optical semiconductor elements such as LEDs. And then the inventers thereby brought the present invention to completion.

That is, the present invention is to provide an addition-curable silicone composition, comprising:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle,
wherein, the inorganic oxide particle contains an organic solvent and a polysilazane compound in which a ratio of a number of repeating units represented by the following formula (2) is 0 to 0.5 relative to a total number of repeating units represented by the following formulae (1) and (2), and is a surface-treated inorganic oxide particle that is surface-treated with a polysilazane compound-containing composition in which an amount of the polysilazane compound is 0.1 to 20% by mass relative to an total amount of the polysilazane compound and the organic solvent

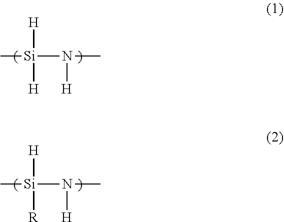

In the formulae, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.

Further, as a method for manufacturing such an addition-curable silicone composition, the present invention provides the following method. That is, the method for manufacturing an addition-curable silicone composition comprises:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle,
wherein, the method for manufacturing an addition-curable silicone composition comprises the step of:
providing the inorganic oxide particle;
manufacturing a surface-treated inorganic oxide particle by surface-treating the inorganic oxide particle with a polysilazane compound-containing composition that contains an organic solvent and a polysilazane compound, in which a ratio of a number of repeating units represented by the above formula (2) is 0 to 0.5 relative to a total number of repeating units represented by the above formulae (1) and (2), and in which an amount of the polysilazane compound is 0.1 to 20% by mass relative to a total amount of the polysilazane compound and the organic solvent; and manufacturing the addition-curable silicone composition by mixing the surface-treated inorganic oxide particle with the components (A) to (C).

Hereinafter, the present invention will be described in detail, but the present invention is not limited thereto.

The addition-curable silicone composition of the present invention contains the above-mentioned components (A) to (D), and may further contain various known additives as necessary. Each component will be described below.

### [(A) Organopolysiloxane]

The inventive component (A) is organopolysiloxane that has at least two alkenyl groups having 2 to 10 carbon atoms and being bonded to a silicon atom per molecule, and may be linear or branched organopolysiloxane. The alkenyl group is preferably ones having 2 to 10 carbon atoms, particularly 2 to 6 carbon atoms, such as a vinyl group and an allyl group.

The linear organopolysiloxane typically has a weight average molecular weight (Mw) of 1,500 to 300,000, and preferably 2,000 to 200,000. When the molecular weight is 1,500 or more, there is no risk that the composition will not cure, and when the molecular weight is 300,000 or less, there is no risk that the composition will become more viscous than necessary and will not flow.

Note that, in the present invention, the weight average molecular weight (Mw) of the organopolysiloxane is a value of weight average molecular weight measured by gel permeation chromatography (GPC) under the following conditions using polystyrenes as standard substances.

### [Measurement Conditions]

Eluent: tetrahydrofuran (THF)
Flow amount: 0.6 mL/min
Detector: Differential refractive index detector (RI)
Column: TSK Guard column Super H-L
TSK gel Super H4000 (6.0 mm I.D.×15 cm×1)
TSK gel Super H3000 (6.0 mm I.D.×15 cm×1)
TSK gel Super H2000 (6.0 mm I.D.×15 cm×2) (each manufactured by Tosoh Corporation)
Column temperature: 40° C.
Sample injection amount: 20 μL (THF solution with a concentration of 0.5% by mass)

Specific examples of the above-mentioned linear organopolysiloxane having the alkenyl groups can include the following.

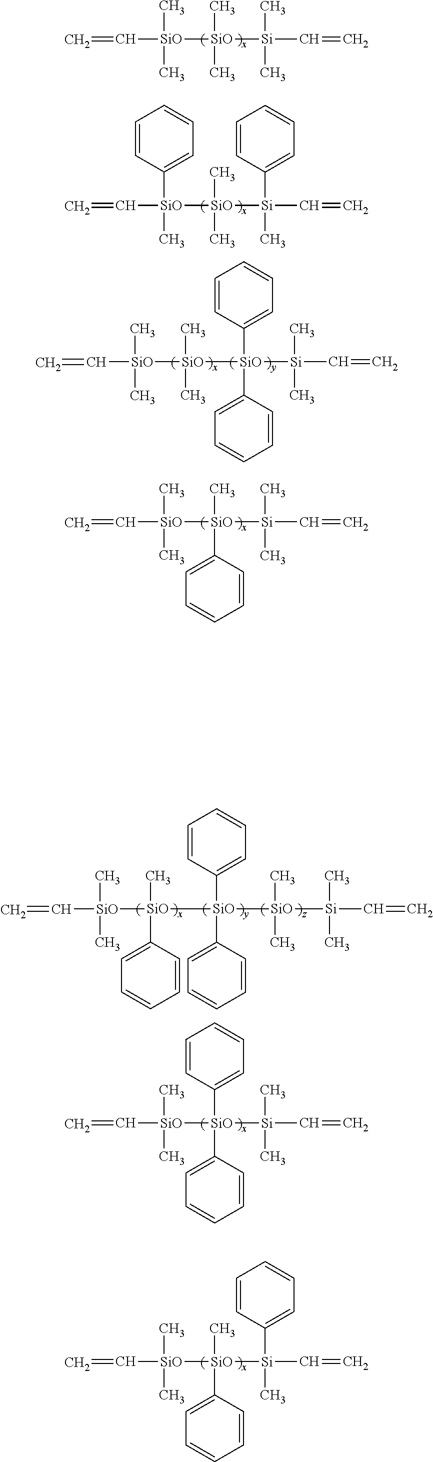

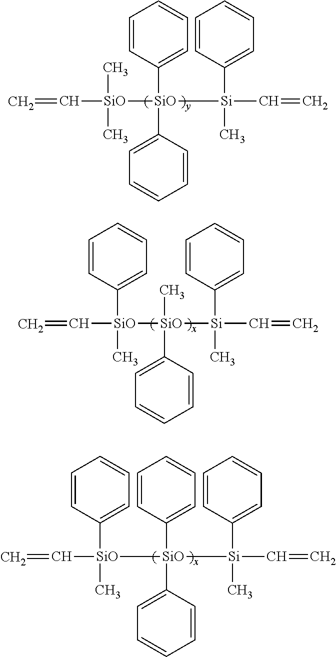

Branched organopolysiloxanes that can be uses as the inventive component (A) are ones having both or either of SiO_{4/2} unit and R¹SiO_{3/2} unit and having at least two alkenyl groups bonded to a silicon atom per molecule. Here, it is preferable that R¹ is independently an unsubstituted or substituted alkyl group having 1 to 10 carbon atoms, an aryl group having 6 to 10 carbon atoms, or an alkenyl group having 2 to 10 carbon atoms.

The branched organopolysiloxane as the component (A) of the present invention has two or more alkenyl groups bonded to a silicon atom per molecule, and the amount of the alkenyl groups contained is preferably 0.01 to 0.5 mol/100 g, more preferably 0.05 to 0.3 mol/100 g, and further preferably 0.10 to 0.25 mol/100 g. When the content of alkenyl groups bonded to a silicon atom is 0.01 mol/100 g or more, the composition has many crosslinking points and can harden, whereas when it is 0.5 mol/100 g or less, the crosslink density is appropriate and toughness can be ensured.

Furthermore, the amount of hydroxyl groups bonded to a silicon atom is preferably 0.001 to 1.0 mol/100 g, more preferably 0.005 to 0.8 mol/100 g, and further preferably 0.008 to 0.6 mol/100 g.

In the branched organopolysiloxane as the component (A) of the present invention, furthermore, the amount of alkoxy groups bonded to silicon atoms and having 1 to 10 carbon atoms, preferably 1 to 5 carbon atoms, is preferably 1.0 mol/100 g or less, more preferably 0.8 mol/100 g or less, and further preferably 0.5 mol/100 g or less. When the amount of alkoxy groups is 1.0 mol/100 g or less, no alcohol gas is generated as a by-product during curing, and no voids remain in the cured product.

In the present invention, the amount of hydroxyl groups and the amount of alkoxy groups bonded to a silicon atom are values measured by ¹H-NMR and ²⁹Si-NMRR.

Furthermore, the branched organopolysiloxane as the component (A) of the present invention is preferably an organopolysiloxane having a resin structure including 0 to 60 mol %, preferably 0 to 50 mol %, of SiO_{4/2} units (Q units), 0 to 90 mol %, preferably 30 to 80 mol %, of R^{1a}SiO_{3/2} units (T units), and 0 to 50 mol %, preferably 0 to 30 mol %, of (R^{1a})₃SiO_{1/2} units (M units), and the sum of the SiO_{4/2} units and the R^{1a}SiO_{3/2} units is preferably 50 mol % or more. In the above formulae, R^{1a} is independently a substituted or unsubstituted alkyl group having 1 to 10 carbon atoms, preferably 2 to 5 carbon atoms, an aryl group having 6 to 10 carbon atoms, preferably 6 to 8 carbon atoms, or an alkenyl group having 2 to 10 carbon atoms, and it is preferable that at least one of the substituents R^{1a} is an alkenyl group having 2 to 10 carbon atoms.

R^{1a} in the M unit and the T unit is independently a substituted or unsubstituted alkyl group having 1 to 10 carbon atoms, an aryl group having 6 to 10 carbon atoms, or an alkenyl group having 2 to 10 carbon atoms. Specific examples thereof include lower alkyl groups such as a methyl group, an ethyl group, a propyl group, and a butyl group; cycloalkyl groups such as a cyclohexyl group; aryl groups such as a phenyl group, a tolyl group, and a xylyl group; aralkyl groups such as a benzyl group, a phenylethyl group, and a phenylpropyl group; alkenyl groups such as a vinyl group, an allyl group, a propenyl group, an isopropenyl group, a butenyl group, a hexenyl group, a cyclohexenyl group, and an octenyl group; and groups in which a portion or all of the hydrogen atoms of these groups have been substituted with halogen atoms such as fluorine, bromine, and chlorine or with cyano groups. These examples can include a chloromethyl group, a cyanoethyl group, and a 3,3,3-trifluoropropyl group, etc. Among them, a methyl group, a phenyl group, and a vinyl groups are preferable.

Examples of materials for obtaining SiO_{4/2} units (Q units) can include sodium silicate, tetraalkoxysilane, and condensation reaction products thereof, but are not limited thereto.

Examples of materials for obtaining R^{1a}SiO_{3/2} units (T units) can include organosilicon compounds represented by the following structural formulae, such as organotrichlorosilane and organotrialkoxysilane, and condensation products thereof, but are not limited thereto.

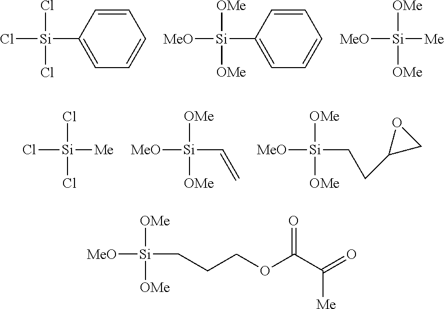

In the above formulae, Me represents a methyl group.

Examples of materials for obtaining (R^{1a})₃SiO_{1/2} units (M units) can include organosilicon compounds represented by the following structural formulae, such as triorganochlorosilane, triorganoalkoxysilane, and hexaorganodisiloxane, but are not limited thereto.

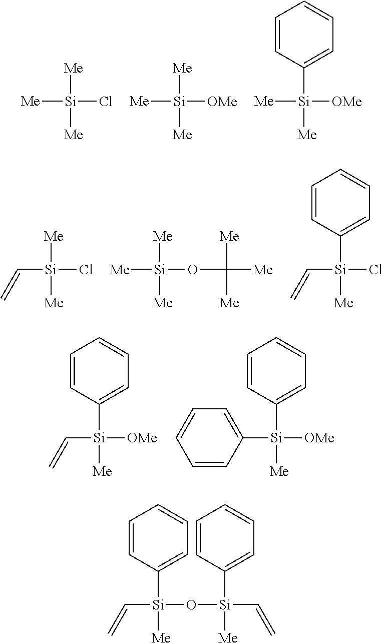

In the above formulae, Me represents a methyl group.

### [(B) Organohydrogenpolysiloxane]

The component (B) of the present invention is an organosilicon compound having two or more silicon-bonded hydrogen atoms (hydrogen atoms bonded to a silicon atom) in one molecule, that is, an organohydrogenpolysiloxane. In other words, the component (B) of the present invention is an organohydrogenpolysiloxane having two or more SiH groups (hydrosilyl groups) in one molecule, which reacts with the component (A) and acts as a crosslinking agent.

The component (B) can be represented by the following average composition formula.

R²ₙHiSiO₍₄₋ₕ₋ᵢ₎/2 (3)

In the average composition formula (3), R² is the same or different, unsubstituted or substituted, monovalent hydrocarbon group having 1 to 10 carbon atoms, and h and i are positive numbers satisfying 0.7≤h≤2.1, 0.001≤i≤1.0, and 0.8≤h+i≤3.0, and preferably 1.0≤h≤2.0, 0.01≤i≤1.0, and 1.5≤h+i≤2.5.

Examples of R² include saturated aliphatic hydrocarbon groups such as a methyl group, an ethyl group, a propyl group, a butyl group, and a pentyl group; saturated cyclic hydrocarbon groups such as a cyclopentyl group and a cyclohexyl group; aromatic hydrocarbon groups such as aryl groups and aralkyl groups; and groups in which the hydrogen atoms bonded to the carbon atoms of these groups are partially or wholly replaced with a halogen atoms such as fluorine, bromine, chlorine, such as halogenated hydrocarbon groups and epoxy groups. The aryl groups include a phenyl group, a tolyl group, and a xylyl group, etc., and aralkyl groups include a benzyl group, a phenylethyl group, a phenylpropyl group, etc. The halogenated hydrocarbon groups include a trifluoropropyl group, a chloropropyl group, etc., and the epoxy groups include an allylglycidyl group, etc. Among these, the saturated aliphatic hydrocarbon groups having 1 to 5 carbon atoms such as a methyl group, an ethyl group, and a propyl group, and a phenyl group are preferable.

The molecular structure of the component (B) is not particularly limited, and any molecular structures, such as linear, cyclic, branched, or three-dimensional network (resin-like), can be used as the component (B). When the component (B) has a linear structure, the hydrosilyl group may be bonded to a silicon atom only at either a molecular chain terminal or a molecular chain side chain, or may be bonded to a silicon atom at the both thereof. In addition, it is possible to use organohydrogenpolysiloxanes that have the number of silicon atoms (or degree of polymerization) per molecule usually 2 to 200, preferably about 3 to 100, and that are liquid or solid at room temperature (25° C.).

Specific examples of the organohydrogenpolysiloxane represented by the above average composition formula (3) can include tris(hydrogendimethylsiloxy)phenylsilane, methylhydrogensiloxane-diphenylsiloxane copolymer having both ends blocked with trimethylsiloxy groups, methylhydrogensiloxane-diphenylsiloxane-dimethylsiloxane copolymer having both ends blocked with trimethylsiloxy groups, methylhydrogensiloxane-methylphenylsiloxane-dimethylsiloxane copolymer having both ends blocked with trimethylsiloxy groups, methylhydrogensiloxane-dimethylsiloxane-diphenylsiloxane copolymer having both ends blocked with dimethylhydrogensiloxy groups, methylhydrogensiloxane-dimethylsiloxane-methylphenylsiloxane copolymer having both ends blocked with dimethylhydrogensiloxy groups, and a copolymer consisting of a (CH₃)₂HSiO_{1/2} unit, a SiO_{4/2} unit, and (C₆H₅)₃SiO_{1/2} unit.

Additionally, the organohydrogenpolysiloxanes represented by the following structures may also be used, but the invention is not limited thereto.

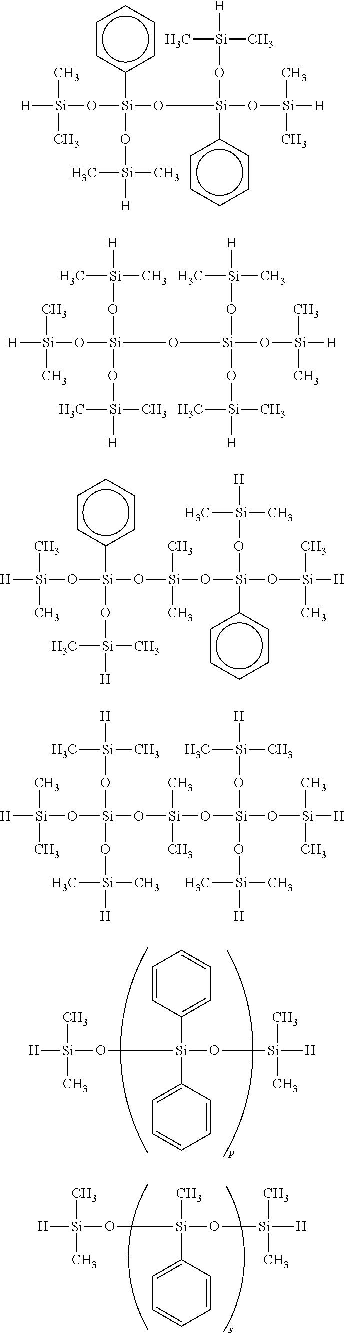

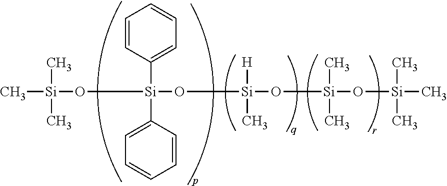

In the above formulae, p, r, and s each are integers more than 0, and q is an integer of 1 or more.

The blended amount of the component (B) is the amount such that the amount of hydrosilyl group of the component (B) is 0.1 to 4.0 moles, more preferably 0.5 to 3.5 moles, and further preferably 0.8 to 3.0 moles, per mole of alkenyl groups bonded to silicon atoms of the component (A).

When the amount of hydrosilyl groups in the component (B) is 0.1 mol or more, the curing reaction of the composition of the present invention can proceeds to obtain a cured product, the crosslink density and mechanical strength of the obtained cured product are sufficient, and the heat resistance is also improved. On the other hand, when the blended amount of the hydrosilyl groups is 4.0 mol or less, a large amount of unreacted hydrosilyl groups do not remain in the cured product, so that the physical properties do not change over time, the heat resistance of the cured product does not decrease, and further, foaming due to dehydrogenation reaction does not occur in the cured product.

### [(C) Platinum Group Metal-Based Catalyst]

The component (C) of the present invention is a platinum group metal-based catalyst, and any conventionally known catalyst can be used as the catalyst that promotes the hydrosilylation reaction of the components (A) and (B). Considering cost etc., platinum-based materials such as platinum, platinum black, chloroplatinic acid; for example, H₂PtCl₆·pH₂O, K₂PtCl₆, KHPtCl₆·pH₂O, K₂PtCl₄, K₂PtCl₄·pH₂O, PtO₂·pH₂O, PtCl₄·pH₂O, PtCl₂, H₂PtCl₄·pH₂O (here, p is a positive integer), etc., complexes of these with hydrocarbons such as olefins, alcohol or vinyl group-containing organopolysiloxanes, or complexes having photoactivity such as trimethyl (methylcyclopentadienyl) platinum. One of the catalysts may be used alone, or two kinds or more of these may be used in combination.

The blended amount of these catalysts may be an effective amount for curing, and is, in general, preferably 0.1 to 500 ppm, specifically preferably in the range of 0.5 to 100 ppm, in terms of a mass as a platinum group metal, relative to the total amount of the components (A) and (B).

### [(D) Inorganic Oxide Particle]

As an inorganic oxide particle of the component (D), a surface-treated inorganic oxide particle is used. This surface treatment will be described later. The blended amount of the component (D) is preferably 1 to 99 mass %, more preferably 25 to 75 mass %, and further preferably 30 to 70 mass %, based on the total amount of the composition. The component (D) may be blended alone or two or more kinds thereof can be blended in combination. When the blended amount of the component (D) is 1 mass % or more, the effect of the inorganic oxide particle can be sufficiently obtained, and when the blended amount is 99 mass % or less, the effect of the silicone can be sufficiently obtained, and it is possible to improve durability of the optical semiconductor device using the cured product.

Examples of the inorganic oxide particle can include silicon dioxide (silica: SiO₂), zirconium oxide (zirconia: ZrO₂), titanium oxide (TiO₂), aluminum oxide (alumina: Al₂O₃), zinc oxide (ZnO), iron oxide (FeO₂), tri-iron tetroxide (Fe₃O₄), lead oxide (PbO₂), tin oxide (SnO₂), cerium oxide (CeO₂), calcium oxide (CaO), tri-manganese tetroxide (Mn₃O₄), and magnesium oxide (MgO). The inorganic oxide particle may be used alone or two or more kinds thereof may be used in combination. Among these, silicon dioxide, zirconium oxide, titanium oxide, aluminum oxide, and zinc oxide are preferable, and titanium oxide is particularly preferable. By adding these inorganic oxide particle to a silicone resin composition, properties of the cured product can be further improved.

### [Polysilazane]

Polysilazane is a component that hardens on the surface of the inorganic oxide particle to form a coating (cured film). The polysilazane compound used in the present invention has a repeating unit represented by the following formulae (1) and (2).

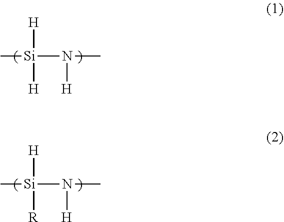

In the above formula (2), R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms. This R is preferably a group selected from the group consisting of an aliphatic hydrocarbon group having 1 to 3 carbon atoms, an aromatic hydrocarbon group having 6 to 8 carbon atoms, and an alkoxy group having 1 to 3 carbon atoms. The examples can include a methyl group, an ethyl group, a phenyl group, a methoxy group, an ethoxy group. Among them, a methyl group is specifically preferable, which is easy to handle and make it difficult for cured film to decrease its hardness. R can be selected for each repeating unit in one polysilazane compound accordingly. Rs may be the same as each other.

Further, in the polysilazane compound, the ratio of the number of repeating units represented by the above formula (2) is 0 to 0.5 relative to the total number of repeating units represented by the following formulae (1) and (2). When the ratio exceeds 0.5, the cured film contains a large amount of organic components, and therefore, there is a risk that heat resistance decreases. Furthermore, the ratio may be 0, that is, a polysilazane compound consisting of repeating units represented by formula (1) may be used.

From the viewpoint of solubility in an organic solvent, which is a component of a dilution solvent, the polysilazane compound preferably has a weight-average molecular weight in the range of 200 to 1,000,000, more preferably 500 to 100,000, and further preferably 1,000 to 20,000. When the weight-average molecular weight is 200 or more, volatility is not high and there is almost no volatilization during drying of organic solvents, and therefore, a uniform surface treatment can be carried out evenly on the surface of the inorganic oxide particle. When the weight-average molecular weight is 1,000,000 or less, the solubility in an organic solvent is good and the dissolution viscosity is not high, so that an efficient surface treatment can be performed.

Note that, in the present invention, the weight average molecular weight (Mw) of the polysilazane compound is a value of weight average molecular weight measured by gel permeation chromatography (GPC) under the following conditions using polystyrene as standard substances.

### [Measurement Conditions]

Eluent: tetrahydrofuran (THF)
Flow amount: 0.6 mL/min
Detector: UV detector
Column: TSK Guard column Super H-L
TSKgel SuperMultiporeHZ-M (4.6 mm I.D.×15 cm×4) (each manufactured by Tosoh Corporation)
Column temperature: 40° C.
Sample injection amount: 20 μL (THF solution with a concentration of 0.5% by mass)

The polysilazane compound having the repeating units represented by the above formulae (1) and (2) may contain a branched structure or a cyclic structure in addition to these repeating units.

In addition, in the polysilazane compound-containing composition, the amount of the polysilazane compound is 0.1 to 20% by mass, more preferably 0.5 to 10% by mass, relative to the total amount of the polysilazane compound and the organic solvent. Within this range, the surfaces of the inorganic oxide particle can be uniformly treated.

### [Organic Solvent]

The polysilazane compound used in the present invention is diluted with an organic solvent for the purpose of improving storage stability and uniformity of surface treatment. The organic solvent is not particularly limited as long as it dissolves the polysilazane compound. For example, saturated aliphatic hydrocarbons such as n-pentane, isopentane, n-hexane, isohexane, n-heptane, isoheptane, n-octane, isooctane, n-nonane, isononane, n-decane, and isodecane; unsaturated aliphatic hydrocarbons such as 1-octene, 1-nonene, 1-decene, 1-dodecene, and p-myrcene; saturated alicyclic hydrocarbons such as cyclopentane, cyclohexane, methylcyclohexane, dimethylcyclohexane, ethylcyclohexane, and decahydronaphthalene; unsaturated alicyclic hydrocarbons such as cyclohexene; terpene compounds such as p-menthane, d-limonene, 1-limonene, and dipentene; aromatic hydrocarbons such as benzene, toluene, xylene, ethylbenzene, diethylbenzene, trimethylbenzene, triethylbenzene, and tetrahydronaphthalene; ketone compounds such as acetone, methyl ethyl ketone, diethyl ketone, methyl isobutyl ketone, di-n-butyl ketone, diisobutyl ketone, cyclopentanone, cyclohexanone, diacetone alcohol; ester compounds such as n-propyl acetate, isopropyl acetate, n-butyl acetate, isobutyl acetate, isoamyl acetate, ethyl acetoacetate, ethyl caproate; alkyl ether compounds such as diethyl ether, di-n-propyl ether, di-n-butyl ether, di-n-pentyl ether, di-n-hexyl ether, and tert-butyl methyl ether; aryl ether compounds such as anisole and diphenyl ether; and glycol ether compounds such as bis(2-methoxyethyl)ether, bis(2-ethoxyethyl)ether, and bis(2-butoxyethyl)ether.

The polysilazane compound-containing composition preferably contains 1,000 ppm or less of water, more preferably 500 ppm or less of water. When a water content is 1000 ppm or less, the polysilazane compound does not react with water, and it is preferable because there is no risk of heat generation, generation of hydrogen gas or ammonia gas, thickening, gelation, etc.

### [Curing Catalyst]

In addition to the polysilazane compound and organic solvent, a curing catalyst can be added to the polysilazane compound-containing composition of the present invention. By adding a curing catalyst, the reaction rate of the polysilazane on the inorganic surfaces can be increased, which is preferable from the viewpoint of workability.

The curing catalyst is preferably, for example, an organosilicon compound having one or more alkoxysilyl groups and one or more amino groups in one molecule, or a compound containing a metal element.

Specific examples of the organosilicon compound include aminosilanes such as 3-aminopropylmethyldimethoxysilane, 3-aminopropyltrimethoxysilane, 3-aminopropyltriethoxysilane, 3-(2-aminoethylamino)propyltrimethoxysilane, and 3-(2-aminoethylamino)propylmethyldiethoxysilane, and partial hydrolysates of these aminosilanes. Among these, 3-aminopropyltrimethoxysilane and 3-aminopropyltriethoxysilane are preferred because they have a high curing rate and excellent workability.

Specific examples of the metal element-containing compound include compounds containing metal elements such as titanium, aluminum, tin, zinc, and palladium. Among these, metal compounds of titanium or aluminum, which are unlikely to cause coloring, are preferable.

The curing catalyst may be added alone or two or more kinds may be added in any combination. The added amount of the curing catalyst is preferably 0.01 to 20 parts by mass, more preferably 0.05 to 10 parts by mass, relative to 100 parts by mass of the polysilazane compound.

A known method can be used for the surface treatment of inorganic oxide particle. The surface treatment method of inorganic oxide particle includes a dry method and a wet method. The wet method using a solution is preferable from the viewpoints of uniform treatment of inorganic oxide particle and prevention of gelation.

The surface treatment method is preferably a method for producing surface-treated inorganic oxide particle that includes reacting the specified inorganic oxide particle with a solution containing the specified polysilazane compound at 20° C. to 150° C. for 1 to 48 hours and performing a heat treatment at 100° C. to 400° C.

This surface treatment can be performed at a sufficiently high rate when the reaction is performed at a temperature of 20° C. or higher. When the reaction is performed at a temperature of 150° C. or lower, the reaction can be easily controlled and gelation and coloring can be prevented. Further, it is easy to make the treatment sufficient when the reaction is performed for 1 hour or more, whereas production efficiency can be improved when the reaction is performed for 48 hours or less.

If necessary, known adhesion promoters and additives can also be blended into the inventive addition-curable silicone composition, in addition to the above components (A) through (D).

### [Adhesion Promoters]

Examples of adhesion promoters include phenyltrimethoxysilane, trimethoxysilane, triethoxysilane, methyldimethoxysilane, diphenyldimethoxysilane, methylphenyldimethoxysilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-methacryloxypropylmethyldiethoxysilane, 3-methacryloxypropyltriethoxysilane, oligomers thereof, etc. The adhesion promoter may be used alone or two or more kinds may be used in combination. Further, the amount of the adhesion promoter is preferably 0 to 10% by mass, more preferably 0 to 5% by mass, relative to the total mass of the above components (A) to (D).

### [Other Additives]

Other additives include, for example, reinforcing inorganic fillers such as glass fiber, fumed silica, and fumed titanium oxide; inorganic white pigments such as calcium carbonate, magnesium oxide, aluminum hydroxide, barium carbonate, magnesium silicate, zinc sulfate, and barium sulfate; non-reinforcing inorganic fillers such as calcium silicate, carbon black, cerium fatty acid salts, barium fatty acid salts, cerium alkoxides, and barium alkoxides; and fillers such as silver (Ag), aluminum (Al), aluminum nitride (AlN), boron nitride (BN), iron oxide (Fe₂O₃), triiron tetroxide (Fe₃O₄), lead oxide (PbO₂), tin oxide (SnO₂), cerium oxide (Ce₂O₃, CeO₂), calcium oxide (CaO), trimanganese tetroxide (Mn₃O₄), and barium oxide (BaO). These can be appropriately blended in an amount of 600 parts by mass or less, preferably 10 to 400 parts by mass, per 100 parts by mass of the total of the above components (A) to (D).

The inventive addition-curable silicone composition can be cured after being applied to a substrate depending on the application. As for the curing conditions, the composition can be sufficiently cured at room temperature (25° C.), but may be cured by heating if necessary. When heating, the composition can be cured at a temperature of, for example, 60 to 200° C.

The inventive addition-curable silicone composition can be used for a variety of applications, for example, such as sealing materials, adhesives, electrical insulating materials, laminates, coatings, inks, paints, sealants, resists, composite materials, films, underfill materials, anti-reflective materials, light diffusing materials, and light reflective materials, but the applications are not limited thereto.

Further, the present invention also provides an optical semiconductor device in which a semiconductor element is encapsulated with a cured product of the inventive addition-curable silicone composition.

Such an addition-curable silicone composition of the present invention can provide a cured product that is excellent in mechanical properties, crack resistance, heat resistance, moisture resistance, and light resistance.

### EXAMPLE

Hereinafter, the present invention will be specifically described with reference to Synthesis Examples, Comparative Synthesis Examples, Examples and Comparative Examples, but the present invention is not limited thereto. Note that, “part” means a parts by mass, and viscosity of each component is the values of absolute viscosity measured at 25° C. with a rotational viscometer described in JIS K 7117-1:1999.

### [Polysilazane Compound-Containing Composition]

As the polysilazane compound-containing compositions, the following PSZ-1 to PSZ-4 were used.

### (PSZ-1)

Product name “X-45-870” [dibutyl ether solution containing perhydropolysilazane], manufactured by Shin-Etsu Chemical Co., Ltd. The amount of polysilazane compound is 20 mass % relative to the total amount of the polysilazane compound and the organic solvent (a 20% polysilazane component solution). It contains curing catalysts in 1%. The weight average molecular weight of the polysilazane compound is 3000. Because it does not contain the repeating unit represented by the above formula (2), the ratio of the number of repeating units represented by formula (2) to the total number of repeating units represented by formulae (1) and (2) is 0.

### (PSZ-2)

Product name “X-45-872” [a dibutyl ether solution containing perhydropolysilazane and methylpolysilazane], manufactured by Shin-Etsu Chemical Co., Ltd. The ratio (hereinafter referred to as “methylpolysilazane ratio”) of the number of repeating units represented by formula (2) relative to the total number of repeating units represented by formulae (1) and (2) is 0.5. The amount of the polysilazane compound is 20 mass % relative to the total amount of the polysilazane compound and the organic solvent (a 20% polysilazane component solution). It contains curing catalysts in 1%. The weight average molecular weight is 1500.

### (PSZ-3)

Product name “X-45-872” [a dibutyl ether solution containing perhydropolysilazane and methylpolysilazane](manufactured by Shin-Etsu Chemical Co., Ltd.) with a methylpolysilazane ratio of 0.25. The polysilazane compound is 20 mass % relative to the total amount of the polysilazane compound and the organic solvent (a 20% polysilazane component solution). It contains curing catalyst in 1%. The weight average molecular weight is 1800.

### (PSZ-4)

Product name “X-45-872” [a dibutyl ether solution containing perhydropolysilazane and methylpolysilazane], manufactured by Shin-Etsu Chemical Co., Ltd., with a methylpolysilazane ratio of 0.7. The polysilazane compound is 20 mass % relative to the total amount of the polysilazane compound and the organic solvent (a 20% polysilazane component solution). It contains curing catalyst in 1%. The weight average molecular weight is 1700.

### [Inorganic Oxide Particle]

As an inorganic oxide particle, the following inorganic oxide particle-1 to -5 are used.

### (Inorganic Oxide Particle-1)

Product name “CR-50” [Titanium Dioxide Powder] manufactured by Ishihara Sangyo Kaisha, Ltd.

### (Inorganic Oxide Particle-2)

Product name “Zinc oxide” [Zinc Oxide Powder] manufactured by Mitsui Mining & Smelting Co., Ltd.

### (Inorganic Oxide Particle-3)

Product name “TZ-3YS-E” [Zirconium oxide] manufactured by manufactured by Tosoh Corporation (Inorganic Oxide Particle-4)

Product Name “ACT-05” [Silicon Dioxide] manufactured by Fumitec Minerals Private Limited

### (Inorganic Oxide Particle-5)

Product Name “AO-502” [Aluminum oxide] manufactured by Admatechs Co., Ltd.

### Synthesis Example 1

In a 300 mL eggplant flask, 10 g of the above PSZ-1, i.e., the polysilazane compound-containing composition “X-45-870” was weighed and added with 190 g of dibutyl ether to prepare a 1% polysilazane solution. After heating and stirring at 70° C. for 1 hour, 100 g of inorganic oxide particle-1 was added, and the mixture was heated and stirred for an additional 3 hours. The treatment solution was removed by pressure filtration, and heat treatment was performed at 250° C. for 4 hours to obtain surface-treated inorganic oxide particle 1 (D-1).

### Synthesis Example 2

Surface-treated inorganic oxide particle 2 (D-2) was obtained by carrying out the same operations as in Synthesis Example 1, except that the polysilazane compound-containing composition “X-45-870” in Synthesis Example 1 was replaced with the above PSZ-2, i.e., “X-45-872.”

### Synthesis Example 3

The same operations as in Synthesis Example 1 was carried out except that the polysilazane compound-containing composition “X-45-870” of Synthesis Example 1 was replaced with the above PSZ-3, i.e., “X-45-872 with a methylpolysilazane ratio of 0.25”, to obtain surface-treated inorganic oxide particle 3 (D-3).

### Synthesis Example 4

In a 300 mL eggplant flask, 50 g of the above PSZ-1, i.e., the polysilazane compound-containing composition “X-45-870” was weighed and added with 150 g of dibutyl ether to prepare a 10% polysilazane solution. After heating and stirring at 70° C. for 1 hour, 100 g of inorganic oxide particle-1 was added, and the mixture was heated and stirred for an additional 3 hours. The treatment solution was removed by pressure filtration, and heat treatment was performed at 250° C. for 4 hours to obtain surface-treated inorganic oxide particle 4 (D-4).

### Synthesis Example 5

Surface-treated inorganic oxide particle 5 (D-5) was obtained by carrying out the same operations as in Synthesis Example 1, except that inorganic oxide particle-2 was used instead of inorganic oxide particle-1 in Synthesis Example 1.

### Synthesis Example 6

Surface-treated inorganic oxide particle 6 (D-6) was obtained by carrying out the same operations as in Synthesis Example 1, except that inorganic oxide particle-3 was used instead of inorganic oxide particle-1 in Synthesis Example 1.

### Synthesis Example 7

Surface-treated inorganic oxide particle 7 (D-7) was obtained by carrying out the same procedure as in Synthesis Example 1, except that inorganic oxide particle-4 was used instead of inorganic oxide particle-1 in Synthesis Example 1.

### Synthesis Example 8

Surface-treated inorganic oxide particle 8 (D-8) was obtained by carrying out the same procedure as in Synthesis Example 1, except that inorganic oxide particle-5 was used instead of inorganic oxide particle-1 in Synthesis Example 1.

### Comparative Synthesis Example 1

In a 300 mL eggplant flask, 10 g of the above PSZ-4, i.e., the polysilazane compound-containing composition “X-45-872” with a methylpolysilazane ratio of 0.7, was weighed and added with 190 g of dibutyl ether was added to prepare a 1% polysilazane solution. After heating at 70° C. for 1 hour, 100 g of inorganic particles-1 was added, and the mixture was heated and stirred for another 3 hours. The treatment solution was removed by pressure filtration, and heat treatment was performed at 250° C. for 4 hours to obtain surface-treated inorganic oxide particle 9 (D-9).

### Comparative Synthesis Example 2

Surface-treated inorganic oxide particle 10 (D-10) was obtained by carrying out the same operations as in Comparative Synthesis Example 1, except that inorganic oxide particle-2 was used instead of inorganic oxide particle-1 in Comparative Synthesis Example 1.

### Comparative Synthesis Example 3

Surface-treated inorganic oxide particle 11 (D-11) was obtained by carrying out the same operations as in Comparative Synthesis Example 1, except that inorganic oxide particle-3 was used instead of inorganic oxide particle-1 in Comparative Synthesis Example 1.

### Comparative Synthesis Example 4

Surface-treated inorganic oxide particle 12 (D-12) was obtained by carrying out the same operations as in Comparative Synthesis Example 1, except that inorganic oxide particle-4 was used instead of inorganic oxide particle-1 in Comparative Synthesis Example 1.

### Comparative Synthesis Example 5

Surface-treated inorganic oxide particle 13 (D-13) was obtained by carrying out the same operations as in Comparative Synthesis Example 1, except that inorganic oxide particle-5 was used instead of inorganic oxide particle-1 in Comparative Synthesis Example 1.

### Comparative Synthesis Example 6

In a 300 mL eggplant flask, 10 g of a silane coupling agent “KBM-04” (manufactured by Shin-Etsu Chemical Co., Ltd.) was weighed and added with 190 g of toluene to prepare a 5% silane coupling agent solution. After heating at 100° C. for 1 hour, 100 g of inorganic oxide particle-1 was added, and the mixture was further heated and stirred for 3 hours. The treatment solution was removed by pressure filtration, and heat treatment was performed at 150° C. for 1 hour to obtain surface-treated inorganic oxide particle 14 (D-14).

### Comparative Synthesis Example 7

In a 300 mL eggplant-shaped flask, 10 g of a silane coupling agent “Ethyl polysilicate 40T” (manufactured by Colcoat Co., Ltd., tetraethoxysilane partial hydrolysis condensate) was weighed, and add with 190 g of toluene to prepare a 5% solution. After heating at 100° C. for 1 hour, 100 g of inorganic oxide particle-1 was added, and the mixture was further heated and stirred for 3 hours. The treatment solution was removed by pressure filtration, and heat treatment was performed at 150° C. for 1 hour to obtain surface-treated inorganic oxide particle 15 (D-15).

### Example 1

An addition-curable silicone composition was prepared by adding the following components and stirred efficiently:
as the component (A), an organopolysiloxane represented by the following formula (A-1): 50 parts;

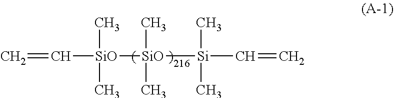

as the component (B), an organohydrogenpolysiloxane represented by the following formula (B-1): the amount such that the ratio (hereinafter, sometimes referred to as the SiH/SiVi ratio) of the total number of silicon-bonded hydrogen atoms in the component (B-1) relative to the total number of silicon-bonded vinyl groups in the component (A-1) is 2.0 (in this case, 1 part by mass);

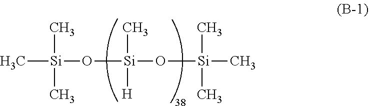

as the component (C), an octyl alcohol modified solution of chloroplatinic acid (platinum element content: 1 mass %): 0.1 parts; and
as the component (D), the prepared surface-treated inorganic oxide particle-1 (D-1): 50 parts. This composition was heated and molded at 150° C. for 4 hours to form a cured product (120 mm×110 mm×1 mm), and the following physical properties were measured. The results are shown in Table 1.

### Example 2

An addition-curable silicone composition was obtained by preparing a composition in the same manner as Example 1, except that 50 parts of surface-treated inorganic oxide particle-2 (D-2) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 3

An addition-curable silicone composition was obtained by preparing a composition in the same manner as Example 1, except that 50 parts of surface-treated inorganic oxide particle-3 (D-3) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 4

An addition-curable silicone composition was obtained by preparing a composition in the same manner as Example 1, except that 50 parts of surface-treated inorganic oxide particle-4 (D-4) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 5

An addition-curable silicone composition was obtained by preparing a composition in the same manner as Example 1, except that 50 parts of surface-treated inorganic oxide particle-5 (D-5) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 6

An addition-curable silicone composition was obtained by preparing a composition in the same manner as Example 1, except that 50 parts of surface-treated inorganic oxide particle-6 (D-6) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 7

An addition-curable silicone composition was obtained by preparing a composition in the same manner as Example 1, except that 50 parts of surface-treated inorganic oxide particle-7 (D-7) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 8

An addition-curable silicone composition was obtained by preparing a composition in the same manner, except that 50 parts of surface-treated inorganic oxide particle-8 (D-8) is used as the component (D) instead of 50 parts of the surface-treated inorganic oxide particle-1 (D-1) used in Example 1. This composition was heated and molded at 150° C. for 4 hours to form a cured product (120 mm×110 mm×1 mm), and the following physical properties were measured. The results are shown in Table 1.

### Example 9

An addition-curable silicone composition was obtained by preparing a composition in the same manner, except that 30 parts of organopolysiloxane (A-1) is used as the component (A) instead of 50 parts used in Example 1 and that 70 parts of surface-treated inorganic oxide particle-1 (D-1) is used as the component (D) instead of 50 parts used in Example 1. This composition was heated and molded at 150° C. for 4 hours to form a cured product (120 mm×110 mm×1 mm), and the following physical properties were measured. The results are shown in Table 1.

### Example 10

An addition-curable silicone composition was obtained by preparing a composition in the same manner as in Example 1, except that 70 parts of the organopolysiloxane (A-1) was used as the component (A) instead of 50 parts used in Example 1, and that 30 parts of the surface-treated inorganic oxide particle-1 (D-1) was used as the component (D) instead of 50 parts used in Example 1. This composition was molded by heating at 150° C. for 4 hours to form a cured product (120 mm×110 mm×1 mm), and the following physical properties were measured. The results are shown in Table 1.

### Comparative Example 1

An addition-curable silicone composition was prepared by adding the following components and stirred efficiently:
as the component (A), an organopolysiloxane represented by the following formula (A-1): 50 parts;

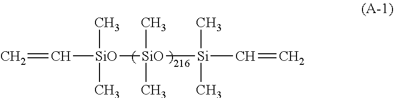

as the component (B), an organohydrogenpolysiloxane represented by the following formula (B-1): the amount such that the ratio (SiH/SiVi ratio) of the total number of silicon-bonded hydrogen atoms in the component (B-1) relative to the total number of silicon-bonded vinyl groups in the component (A-1) is 2.0;

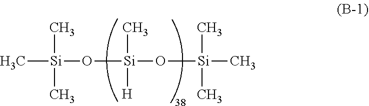

as the component (C), an octyl alcohol modified solution of chloroplatinic acid (platinum element content: 1 mass %): 0.1 parts; and
as the component (D), untreated inorganic oxide particle-1 (D-1): 50 parts. This composition was heated and molded at 150° C. for 4 hours to form a cured product (120 mm×110 mm×1 mm), and the following physical properties were measured. The results are shown in Table 2.

### Comparative Example 2

An addition-curable silicone composition was obtained by preparing a composition in the same manner as Comparative Example 1, except that 50 parts of inorganic oxide particle-2 is used as the component (D) instead of 50 parts of the surface-treated inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 3

An addition-curable silicone composition was obtained by preparing a composition in the same manner as Comparative Example 1, except that 50 parts of inorganic oxide particle-3 is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 4

An addition-curable silicone composition was obtained by preparing a composition in the same manner as Comparative Example 1, except that 50 parts of inorganic oxide particle-4 is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 5

An addition-curable silicone composition was obtained by preparing a composition in the same manner as Comparative Example 1, except that 50 parts of inorganic oxide particle-5 is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 6

An addition-curable silicone composition was obtained by preparing a composition in the same manner as Comparative Example 1, except that 50 parts of the surface-treated inorganic oxide particle-9 (D-9) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 7

An addition-curable silicone composition was obtained by preparing a composition in the same manner as Comparative Example 1, except that 50 parts of the surface-treated inorganic oxide particle-10 (D-10) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 8

An addition-curable silicone composition was obtained by preparing a composition in the same manner as Comparative Example 1, except that 50 parts of the surface-treated inorganic oxide particle-11 (D-11) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 9

An addition-curable silicone composition was obtained by preparing a composition in the same manner as Comparative Example 1, except that 50 parts of the surface-treated inorganic oxide particle-12 (D-12) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 10

An addition-curable silicone composition was obtained by preparing a composition in the same manner as Comparative Example 1, except that 50 parts of the surface-treated inorganic oxide particle-13 (D-13) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 11

An addition-curable silicone composition was obtained by preparing a composition in the same manner as Comparative Example 1, except that 50 parts of the surface-treated inorganic oxide particle-14 (D-14) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 12

An addition-curable silicone composition was obtained by preparing a composition in the same manner as Comparative Example 1, except that 50 parts of the surface-treated inorganic oxide particle-15 (D-15) is used as the component (D) instead of 50 parts of the inorganic oxide particle-1 used in Comparative Example 1. This composition was heated and molded at 150° C. for 4 hours to form a cured product (120 mm×110 mm×1 mm), and the following physical properties were measured. The results are shown in Table 2.

### Comparative Example 13

An addition-curable silicone composition was obtained by preparing a composition in the same manner as Comparative Example 1, except that 30 parts of the organopolysiloxane (A-1) was used as the component (A) instead of 50 parts used in Comparative Example 1, and that 70 parts of inorganic oxide particle-1 was used as the component (D) instead of 50 parts used in Comparative Example 1. This composition was molded by heating at 150° C. for 4 hours to form a cured product (120 mm×110 mm×1 mm), and the following physical properties were measured. The results are shown in Table 2.

### Comparative Example 14

An addition-curable silicone composition was obtained by preparing a composition in the same manner as Comparative Example 1, except that 70 parts of the organopolysiloxane (A-1) was used as the component (A) instead of 50 parts used in Comparative Example 1, and that 30 parts of inorganic oxide particle-1 was used as the component (D) instead of 50 parts used in Comparative Example 1. This composition was molded by heating at 150° C. for 4 hours to form a cured product (120 mm×110 mm×1 mm), and the following physical properties were measured. The results are shown in Table 2.

The physical properties of each of the compositions prepared in Examples 1 to 8 and Comparative Examples 1 to 14 and the cured products of these were measured according to the following methods. The results are shown in Tables 1 and 2.

### (1) Appearance

The cured product (1 mm) obtained by curing each composition at 150° C. for 4 hours were visually observed in light of color, transparency, and presence of void.

### (2) Properties

The fluidity of each composition before curing was checked. 50 g of the composition was added to a 100 ml glass bottle, which was then turned on its side and left to stand at 25° C. for 10 minutes. When the resin flowed out during that time, it was determined to be liquid.

### (3) Viscosity

Viscosity of each composition before curing was measured at 25° C. according to the method described in JIS K 7117-1:1999.

### (4) Thixotropy Ratio

Viscosity at 10 rpm and 1 rpm of each composition before curing was measured at 25° C. according to the method described in JIS K 7117-1:1999, and thixotropy ratios were calculated as a ratio of “viscosity at 1 rpm/viscosity at 10 rpm.”

### (5) Hardness (Type A)

The hardness of the cured product obtained by curing each composition at 150° C. for 4 hours was measured with using a type A durometer according to JIS K 6249:2003.

### (6) Elongation at Break and Tensile Strength

The elongation at break and the tensile strength of the cured product obtained by curing each composition at 150° C. for 4 hours were measured according to JIS K 6249:2003.

### (7) Heat Resistance Test

The cured product obtained by curing each composition at 150° C. for 4 hours was left to stand in the atmosphere at 250° C. for 1000 hours, and its change in hardness was checked. In addition, the resin was applied on a slide glass (25 mm×75 mm×1 mm) so as to have a thickness of 250 μm, and was cured similarly at 150° C. for 4 hours. The obtained cured product was left to stand in the atmosphere at 250° C. for 1000 hours, and the appearance was checked.

### (Appearance Criteria)

Good: No crack
Slightly poor: Cracks (partially)
Poor: Cracks

### (8) Moisture Resistance Test

The cured product obtained by curing each composition at 150° C. for 4 hours was left to stand in the atmosphere at 135° C. and 85% Rh as HAST and left to stand for 1000 hours to check the change in hardness. In addition, the resin was applied on a slide glass (25 mm×75 mm×1 mm) so as to have a thickness of 250 μm, and was cured similarly at 150° C. for 4 hours and left to stand in the atmosphere at 135° C. and 85% Rh for 1000 hours as HAST to check its appearance.

### (Appearance Criteria)

Good: No crack
Slightly poor: Crack (partially)
Poor: Cracks

TABLE 1

| Examples | | 1 | 2 | 3 | 4 | 5 | 6 | 7 | 8 | 9 | 10 |
|---|---|---|---|---|---|---|---|---|---|---|---|
| Organopolysiloxane (A-1) | | 50 | 50 | 50 | 50 | 50 | 50 | 50 | 50 | 30 | 70 |
| Organohydrogen- | | 1 | 1 | 1 | 1 | 1 | 1 | 1 | 1 | 0.6 | 1.4 |
| polysiloxane (B-1) | | | | | | | | | | | |
| Octyl alcohol solution of | | 0.1 | 0.1 | 0.1 | 0.1 | 0.1 | 0.1 | 0.1 | 0.1 | 0.1 | 0.1 |
| chloroplatinic acid (C) | | | | | | | | | | | |
| Surface-treated | | 50 | | | | | | | | 70 | 30 |
| inorganic oxide particle-1 | | | | | | | | | | | |
| (D-1) | | | | | | | | | | | |
| Surface-treated | | | 50 | | | | | | | | |
| inorganic oxide particle-2 | | | | | | | | | | | |
| (D-2) | | | | | | | | | | | |
| Surface-treated | | | | 50 | | | | | | | |
| inorganic oxide particle-3 | | | | | | | | | | | |
| (D-3) | | | | | | | | | | | |
| Surface-treated | | | | | 50 | | | | | | |
| inorganic oxide particle-4 | | | | | | | | | | | |
| (D-4) | | | | | | | | | | | |
| Surface-treated | | | | | | 50 | | | | | |
| inorganic oxide particle-5 | | | | | | | | | | | |
| (D-5) | | | | | | | | | | | |
| Surface-treated | | | | | | | 50 | | | | |
| inorganic oxide particle-6 | | | | | | | | | | | |
| (D-6) | | | | | | | | | | | |
| Surface-treated | | | | | | | | 50 | | | |
| inorganic oxide particle-7 | | | | | | | | | | | |
| (D-7) | | | | | | | | | | | |
| Surface-treated | | | | | | | | | 50 | | |
| inorganic oxide particle-8 | | | | | | | | | | | |
| (D-8) | | | | | | | | | | | |
| Properties | | Liquid | Liquid | Liquid | Liquid | Liquid | Liquid | Liquid | Liquid | Liquid | Liquid |
| Viscosity 1 rpm (Pa · s) | | 10 | 17 | 13 | 10 | 8 | 14 | 25 | 40 | 120 | 6 |
| Viscosity 10 rpm (Pa · s) | | 5 | 6 | 6 | 5 | 4 | 5 | 10 | 12 | 38 | 3 |
| Thixotropy ratio | | 2.0 | 2.8 | 2.2 | 2.0 | 2.0 | 2.8 | 2.5 | 3.3 | 3.2 | 2.0 |
| Appearance | Color/ | White | White | White | White | White | White | White | White | White | White |
| of | Transparency | | | | | | | | | | |
| the cured | Void | Absent | Absent | Absent | Absent | Absent | Absent | Absent | Absent | Absent | Absent |
| product | | | | | | | | | | | |

| | | | | | | | | | | |
|---|---|---|---|---|---|---|---|---|---|---|
| Tensile strength (MPa) | 2.5 | 2.7 | 2.6 | 2.7 | 2.6 | 2.8 | 3.0 | 2.9 | 3.8 | 2.2 |
| Elongation at break (%) | 110 | 100 | 110 | 100 | 100 | 110 | 95 | 105 | 70 | 130 |
| Hardness (Type A) | 56 | 56 | 55 | 55 | 55 | 56 | 57 | 57 | 64 | 50 |
| Hardness (Type A) | 54 | 54 | 55 | 54 | 56 | 55 | 58 | 57 | 65 | 51 |
| after heat-resistance test | | | | | | | | | | |
| Appearance | Good | Good | Good | Good | Good | Good | Good | Good | Good | Good |
| after heat-resistance test | | | | | | | | | | |
| Hardness (Type A) | 58 | 58 | 59 | 58 | 56 | 57 | 59 | 58 | 65 | 51 |
| after HAST | | | | | | | | | | |
| Appearance | Good | Good | Good | Good | Good | Good | Good | Good | Good | Good |
| after HAST | | | | | | | | | | |

TABLE 2

| Comparative Example | | 1 | 2 | 3 | 4 | 5 | 6 | 7 |
|---|---|---|---|---|---|---|---|---|
| Organopolysiloxane | | 50 | 50 | 50 | 50 | 50 | 50 | 50 |
| (A-1) | | | | | | | | |
| Organohydrogen- | | 1 | 1 | 1 | 1 | 1 | 1 | 1 |
| polysiloxane (B-1) | | | | | | | | |
| Octyl alcohol | | 0.1 | 0.1 | 0.1 | 0.1 | 0.1 | 0.1 | 0.1 |
| solution | | | | | | | | |
| of chloroplatinic | | | | | | | | |
| acid (C) | | | | | | | | |
| Inorganic oxide | | 50 | | | | | | |
| particle-1 | | | | | | | | |
| Inorganic oxide | | | 50 | | | | | |
| particle-2 | | | | | | | | |
| Inorganic oxide | | | | 50 | | | | |
| particle-3 | | | | | | | | |
| Inorganic oxide | | | | | 50 | | | |
| particle-4 | | | | | | | | |
| Inorganic oxide | | | | | | 50 | | |
| particle-5 | | | | | | | | |
| Surface-treated | | | | | | | 50 | |
| inorganic oxide | | | | | | | | |
| particle-9 | | | | | | | | |
| (D-9) | | | | | | | | |
| Surface-treated | | | | | | | | 50 |
| inorganic oxide | | | | | | | | |
| particle-10 | | | | | | | | |
| (D-10) | | | | | | | | |
| Surface-treated | | | | | | | | |
| inorganic oxide | | | | | | | | |
| particle-11 | | | | | | | | |
| (D-11) | | | | | | | | |
| Surface-treated | | | | | | | | |
| inorganic oxide | | | | | | | | |
| particle-12 | | | | | | | | |
| (D-12) | | | | | | | | |
| Surface-treated | | | | | | | | |
| inorganic oxide | | | | | | | | |
| particle-13 | | | | | | | | |
| (D-13) | | | | | | | | |
| Surface-treated | | | | | | | | |
| inorganic oxide | | | | | | | | |
| particle-14 | | | | | | | | |
| (D-14) | | | | | | | | |
| Surface-treated | | | | | | | | |
| inorganic oxide | | | | | | | | |
| particle-15 | | | | | | | | |
| (D-15) | | | | | | | | |
| Properties | | Liquid | Liquid | Liquid | Liquid | Liquid | Liquid | Liquid |
| Viscosity 1 rpm | | 21 | 50 | 70 | 30 | 75 | 26 | 38 |
| (Pa · s) | | | | | | | | |
| Viscosity 10 rpm | | 10 | 15 | 19 | 13 | 24 | 9 | 12 |
| (Pa · s) | | | | | | | | |
| Thixotropy ratio | | 2.1 | 3.3 | 3.7 | 2.3 | 3.1 | 2.9 | 3.2 |
| Appear- | Color/ | White | White | White | White | White | White | White |
| ance of | Trans- | | | | | | | |
| the cured | parency | | | | | | | |
| product | Void | Absent | Absent | Absent | Absent | Absent | Absent | Absent |
| Tensile strength | | 2.6 | 2.4 | 2.8 | 2.7 | 2.9 | 2.8 | 2.9 |
| (MPa) | | | | | | | | |
| Elongation at | | 100 | 100 | 120 | 110 | 95 | 100 | 100 |
| break (%) | | | | | | | | |
| Hardness (Type A) | | 54 | 56 | 56 | 57 | 58 | 57 | 57 |
| Hardness(Type A) | | 80 | 94 | 95 | 93 | 93 | 70 | 68 |
| after heat-resistance | | | | | | | | |
| test | | | | | | | | |
| Appearance | | Fair | Poor | Poor | Poor | Poor | Fair | Fair |
| after heat-resistance | | | | | | | | |
| test | | | | | | | | |
| Hardness (Type A) | | 78 | 84 | 85 | 81 | 82 | 57 | 58 |
| after HAST | | | | | | | | |
| Appearance | | Slightly | Poor | Poor | Poor | Poor | Good | Good |
| after HAST | | poor | | | | | | |
| Comparative Example | | 8 | 9 | 10 | 11 | 12 | 13 | 14 |
| Organopolysiloxane | | 50 | 50 | 50 | 50 | 50 | 30 | 70 |
| (A-1) | | | | | | | | |
| Organohydrogen- | | 1 | 1 | 1 | 1 | 1 | 0.6 | 1.4 |
| polysiloxane (B-1) | | | | | | | | |
| Octyl alcohol | | 0.1 | 0.1 | 0.1 | 0.1 | 0.1 | 0.1 | 0.1 |
| solution | | | | | | | | |
| of chloroplatinic | | | | | | | | |
| acid (C) | | | | | | | | |
| Inorganic oxide | | | | | | | 70 | 30 |
| particle-1 | | | | | | | | |
| Inorganic oxide | | | | | | | | |
| particle-2 | | | | | | | | |
| Inorganic oxide | | | | | | | | |
| particle-3 | | | | | | | | |
| Inorganic oxide | | | | | | | | |
| particle-4 | | | | | | | | |
| Inorganic oxide | | | | | | | | |
| particle-5 | | | | | | | | |
| Surface-treated | | | | | | | | |
| inorganic oxide | | | | | | | | |
| particle-9 | | | | | | | | |
| (D-9) | | | | | | | | |
| Surface-treated | | | | | | | | |
| inorganic oxide | | | | | | | | |
| particle-10 | | | | | | | | |
| (D-10) | | | | | | | | |
| Surface-treated | | 50 | | | | | | |
| inorganic oxide | | | | | | | | |
| particle-11 | | | | | | | | |
| (D-11) | | | | | | | | |
| Surface-treated | | | 50 | | | | | |
| inorganic oxide | | | | | | | | |
| particle-12 | | | | | | | | |
| (D-12) | | | | | | | | |
| Surface-treated | | | | 50 | | | | |
| inorganic oxide | | | | | | | | |
| particle-13 | | | | | | | | |
| (D-13) | | | | | | | | |
| Surface-treated | | | | | 50 | | | |
| inorganic oxide | | | | | | | | |
| particle-14 | | | | | | | | |
| (D-14) | | | | | | | | |
| Surface-treated | | | | | | 50 | | |
| inorganic oxide | | | | | | | | |
| particle-15 | | | | | | | | |
| (D-15) | | | | | | | | |
| Properties | | Liquid | Liquid | Liquid | Liquid | Liquid | Liquid | Liquid |
| Viscosity 1 rpm | | 45 | 23 | 48 | 20 | 22 | 250 | 16 |
| (Pa · s) | | | | | | | | |
| Viscosity 10 rpm | | 14 | 10 | 14 | 6 | 7 | 50 | 8 |
| (Pa · s) | | | | | | | | |
| Thixotropy ratio | | 3.2 | 2.3 | 3.4 | 3.3 | 3.1 | 5.0 | 2.0 |
| Appear- | Color/ | White | White | White | White | White | White | White |
| ance of | Trans- | | | | | | | |
| the cured | parency | | | | | | | |
| product | Void | Absent | Absent | Absent | Absent | Absent | Present | Absent |

| | | | | | | | |
|---|---|---|---|---|---|---|---|
| Tensile strength | 3.1 | 3.0 | 3.1 | 2.8 | 2.9 | 3.7 | 2.1 |
| (MPa) | | | | | | | |
| Elongation at | 110 | 130 | 110 | 120 | 100 | 75 | 140 |
| break (%) | | | | | | | |
| Hardness (Type A) | 58 | 56 | 57 | 40 | 55 | 65 | 51 |
| Hardness(Type A) | 69 | 69 | 67 | 85 | 88 | 88 | 78 |
| after heat-resistance | | | | | | | |
| test | | | | | | | |
| Appearance | Fair | Fair | Fair | Poor | Poor | Poor | Fair |
| after heat-resistance | | | | | | | |
| test | | | | | | | |
| Hardness (Type A) | 56 | 57 | 54 | 81 | 82 | 85 | 77 |
| after HAST | | | | | | | |
| Appearance | Good | Good | Good | Poor | Poor | Poor | Slightly |
| after HAST | | | | | | | poor |

As shown in Table 1, in Examples 1 to 10, in which the surface-treated inorganic oxide particle satisfying the conditions of the present invention was used as the component (D), the cured products excellent in sufficient viscosity, appearance, tensile strength, elongation at break, heat resistance, moisture resistance, and crack resistance were obtained. On the other hand, in Comparative Examples 1 to 5, in which the inorganic oxide particle that was not treated with a polysilazane compound was used, the viscosity was high to create a workability problem, and furthermore, the hardness of the cured product significantly increased to have cracks also in the resin after the heat resistance test and the moisture resistance test. In addition, also in Comparative Examples 6 to 10, in which the surface-treated inorganic oxide particle treated with the polysilazane compound that does not meet the specified ranges satisfying the condition of the present invention was used, an increase (deterioration of heat resistance) in the hardness of the cured product after the heat resistance test and an increase in resin viscosity were observed. Furthermore, in Comparative Examples 11 and 12, in which the surface-treated inorganic oxide particles treated with a commonly used silane coupling agent were used, although a sufficient decrease in viscosity was observed, there were problems with heat resistance, moisture resistance, and crack resistance. Further, in Comparative Example 13, in which the content of the inorganic oxide particle was increased, there was also a problem of voids occurring in the cured product due to significant increases in viscosity and thixotropy ratio. In Comparative Example 14, the content of inorganic oxide particles was reduced, but no improvement in heat resistance, moisture resistance, or crack resistance was observed. As described above, the addition-curable silicone composition of the present invention can provide the cured product that was excellent in workability, mechanical properties, heat resistance, moisture resistance, and crack resistance.

The present description includes the following inventions.
[1]: An addition-curable silicone composition, comprising:
   (A) organopolysiloxane having at least two alkenyl groups having 2 to 10 carbon atoms and being bonded to a silicon atom per molecule;
   (B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
   (C) a platinum group metal-based catalyst, wherein an amount of the platinum group metal-based catalyst is a catalytic amount; and
   (D) an inorganic oxide particle,
   wherein, the inorganic oxide particle contains an organic solvent and a polysilazane compound in which a ratio of a number of repeating units represented by the following formula (2) is 0 to 0.5 relative to a total number of repeating units represented by the following formulae (1) and (2), and is a surface-treated inorganic oxide particle that is surface-treated with a polysilazane compound-containing composition in which an amount of the polysilazane compound is 0.1 to 20% by mass relative to an total amount of the polysilazane compound and the organic solvent,

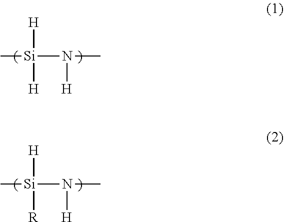

wherein in the formulae, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.
[2]: The addition-curable silicone composition of the above [1], wherein R in the formula (2) of the polysilazane compound is a methyl group.
[3]: The addition-curable silicone composition of the above [1] or [2], wherein the polysilazane compound-containing composition contains a curing catalyst.
[4]: The addition-curable silicone composition of any one of the above [1] to [3], wherein the inorganic oxide particle contains at least one kind selected from the group consisting of silicon dioxide, zirconium oxide, titanium oxide, aluminum oxide, and zinc oxide.
[5]: An optical semiconductor device, comprising a cured product of the addition-curable silicone composition of any one of the above [1] to [4].
[6]: A method for manufacturing an addition-curable silicone composition, comprising:
   (A) organopolysiloxane having at least two alkenyl groups having 2 to 10 carbon atoms and being bonded to a silicon atom per molecule;
   (B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
   (C) a platinum group metal-based catalyst, wherein an amount of the platinum group metal-based catalyst is a catalytic amount; and
   (D) an inorganic oxide particle, wherein, the method for manufacturing an addition-curable silicone composition comprises the step of:
   providing the inorganic oxide particle;
   manufacturing a surface-treated inorganic oxide particle by surface-treating the inorganic oxide particle with a polysilazane compound-containing composition that contains an organic solvent and a polysilazane compound, in which a ratio of a number of repeating units represented by the following formula (2) is 0 to 0.5 relative to a total number of repeating units represented by the following formulae (1) and (2), and in which an amount of the polysilazane compound is 0.1 to 20% by mass relative to a total amount of the polysilazane compound and the organic solvent; and
   manufacturing the addition-curable silicone composition by mixing the surface-treated inorganic oxide particle with the components (A) to (C),

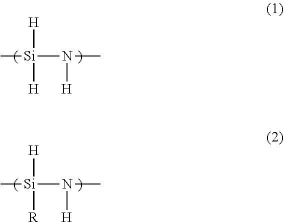

wherein in the formulae, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1. An addition-curable silicone composition, comprising:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle,
wherein, the inorganic oxide particle contains an organic solvent and a polysilazane compound in which a ratio of a number of repeating units represented by the following formula (2) is 0 to 0.5 relative to a total number of repeating units represented by the following formulae (1) and (2), and is a surface-treated inorganic oxide particle that is surface-treated with a polysilazane compound-containing composition in which an amount of the polysilazane compound is 0.1 to 20% by mass relative to an total amount of the polysilazane compound and the organic solvent, 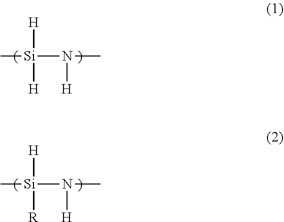
wherein in the formulae, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.

2. The addition-curable silicone composition according to claim 1, wherein R in the formula (2) of the polysilazane compound is a methyl group.

3. The addition-curable silicone composition according to claim 1, wherein the polysilazane compound-containing composition contains a curing catalyst.

4. The addition-curable silicone composition according to claim 1, wherein the inorganic oxide particle contains at least one kind selected from the group consisting of silicon dioxide, zirconium oxide, titanium oxide, aluminum oxide, and zinc oxide.

5. An optical semiconductor device, comprising a cured product of the addition-curable silicone composition according to claim 1.

6. A method for manufacturing an addition-curable silicone composition, comprising:
(A) organopolysiloxane having at least two alkenyl groups having 2 to 10 carbon atoms and being bonded to a silicon atom per molecule;
(B) an organosilicon compound having at least two silicon atom-bonded hydrogen atoms per molecule, wherein an amount of the silicon atom-bonded hydrogen atoms in the component (B) is 0.1 to 4.0 mol relative to 1 mol of the alkenyl groups in the component (A);
(C) a platinum group metal-based catalyst, wherein an amount of the platinum group metal-based catalyst is a catalytic amount; and
(D) an inorganic oxide particle,
wherein, the method for manufacturing an addition-curable silicone composition comprises the step of:
providing the inorganic oxide particle;
manufacturing a surface-treated inorganic oxide particle by surface-treating the inorganic oxide particle with a polysilazane compound-containing composition that contains an organic solvent and a polysilazane compound, in which a ratio of a number of repeating units represented by the following formula (2) is 0 to 0.5 relative to a total number of repeating units represented by the following formulae (1) and (2), and in which an amount of the polysilazane compound is 0.1 to 20% by mass relative to a total amount of the polysilazane compound and the organic solvent; and
manufacturing the addition-curable silicone composition by mixing the surface-treated inorganic oxide particle with the components (A) to (C), 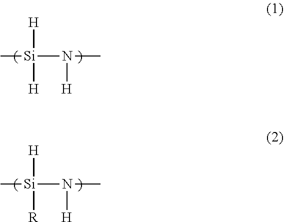
wherein, R represents a group selected from the group consisting of an aliphatic hydrocarbon group having 1 to 6 carbon atoms, an aromatic hydrocarbon group having 6 to 12 carbon atoms, and an alkoxy group having 1 to 6 carbon atoms, and Rs in a polysilazane compound molecule may be the same or different each other.
